(19) United States
(12) Patent Application Publication
(10) Pub. No.: US 2026/0230398 A1
(43) Pub. Date: Aug. 6, 2026

(54) EVENT-TRIGGERED ACTIVATION AND DEACTIVATION OF MACHINE LEARNING FUNCTIONALITY

(71) Applicant: QUALCOMM Incorporated, San Diego, CA (US)

(72) Inventors: Hamed PEZESHKI, San Diego, CA (US); Mahmoud TAHERZADEH BOROUJENI, San Diego, CA (US); Qiaoyu LI, Beijing (CN)

(21) Appl. No.: 19/152,754

(22) PCT Filed: Apr. 7, 2023
(86) PCT No.: PCT/CN2023/086873

§ 371 Date: Jul. 31, 2025

(51) Int. Cl. H04L 41/16; H04B 7/06

(52) U.S. Cl. CPC H04L 41/16; H04B 7/06964

(57) ABSTRACT

Methods, systems, and devices for wireless communications are described. According to techniques described herein, the network entity may configure a user equipment (UE) to activate or deactivate artificial intelligence (AI)/machine-learning (ML) functionality (e.g., or AI/ML models) based on one or more triggering events taking place. In some examples, the triggering event may be a beam failure detection. In some examples, the triggering event may be detecting that the UE has entered a geographic location corresponding to a particular zone identifier (zone ID). In some examples, the triggering event may be based on one or more parameters satisfying a threshold.

### CROSS REFERENCE

The present Application is a 371 national phase filing of International PCT Application No. PCT/CN2023/086873 by PEZESHKI et al., entitled “EVENT-TRIGGERED ACTIVATION AND DEACTIVATION OF MACHINE LEARNING FUNCTIONALITY,” filed Apr. 7, 2023, which is assigned to the assignee hereof, and which is expressly incorporated by reference in its entirety herein.

### FIELD OF TECHNOLOGY

The following relates to wireless communications, including event-triggered activation and deactivation of machine learning functionality.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support event-triggered activation and deactivation of machine learning (ML) functionality. For example, according to techniques described herein, the network entity may configure a user equipment (UE) to activate or deactivate artificial intelligence (AI)/machine-learning functionality (e.g., or AI/ML models) based on one or more triggering events taking place. In some examples, the triggering event may be a beam failure detection. In some examples, the triggering event may be detecting that the UE has entered a geographic location corresponding to a particular zone identifier (zone ID). In some examples, the triggering event may be based on one or more parameters satisfying a threshold.

A method for wireless communications at a user equipment (UE) is described. The method may include performing wireless communications using a functionality of a ML model used to maintain a wireless communications link, detecting a triggering event associated with deactivation of the functionality of the ML model, and deactivating the functionality of the ML model based on the detecting.

An apparatus for wireless communications at a UE is described. The apparatus may include a processor, memory coupled with the processor, and instructions stored in the memory. The instructions may be executable by the processor to cause the apparatus to perform wireless communications using a functionality of a ML model used to maintain a wireless communications link, detect a triggering event associated with deactivation of the functionality of the ML model, and deactivate the functionality of the ML model based on the detecting.

Another apparatus for wireless communications at a UE is described. The apparatus may include means for performing wireless communications using a functionality of a ML model used to maintain a wireless communications link, means for detecting a triggering event associated with deactivation of the functionality of the ML model, and means for deactivating the functionality of the ML model based on the detecting.

A non-transitory computer-readable medium storing code for wireless communications at a UE is described. The code may include instructions executable by a processor to perform wireless communications using a functionality of a ML model used to maintain a wireless communications link, detect a triggering event associated with deactivation of the functionality of the ML model, and deactivate the functionality of the ML model based on the detecting.

Some examples of the method, apparatuses, and non-transitory computer-readable medium described herein may further include operations, features, means, or instructions for receiving control signaling including an indication of the triggering event, where detecting the triggering event may be based on receiving the control signaling.

Some examples of the method, apparatuses, and non-transitory computer-readable medium described herein may further include operations, features, means, or instructions for transmitting a deactivation report including an indication that the UE may have deactivated the functionality of the ML model.

Some examples of the method, apparatuses, and non-transitory computer-readable medium described herein may further include operations, features, means, or instructions for continuing to perform wireless communications via the wireless communications link based on deactivating the functionality of the ML model.

In some examples of the method, apparatuses, and non-transitory computer-readable medium described herein, detecting the triggering event may include operations, features, means, or instructions for monitoring reference signals for one or more beam failures, initiating a beam failure detection timer based on the monitoring and detecting a first beam failure instance including a block error rate corresponding to a first reference signal failing to satisfy a block error rate threshold, and detecting a beam failure based on a quantity of beam failure instances occurring before expiration of the beam failure detection timer satisfies a threshold quantity.

Some examples of the method, apparatuses, and non-transitory computer-readable medium described herein may further include operations, features, means, or instructions for receiving control signaling corresponding to a beam failure recovery procedure, the control signaling including an indication of the beam failure detection timer, the block error rate threshold, and the threshold quantity and transmitting a beam failure report indicating the beam failure based on detecting the beam failure, where deactivating the functionality of the ML model may be based on transmitting the beam failure report.

Some examples of the method, apparatuses, and non-transitory computer-readable medium described herein may further include operations, features, means, or instructions for receiving control signaling indicating event parameters to use to activate or deactivate the functionality of the ML model, the control signaling including an indication of a value of a beam failure detection timer, a value of a block error rate threshold, and a value of a threshold quantity that may be associated with activating or deactivating the functionality of the ML model, where detecting the triggering event may be based on the event parameters.

In some examples of the method, apparatuses, and non-transitory computer-readable medium described herein, detecting the triggering event may include operations, features, means, or instructions for detecting an entering into a geographic region associated with a zone identifier, where deactivating the functionality of the ML model may be based on detecting the entering the geographic region.

Some examples of the method, apparatuses, and non-transitory computer-readable medium described herein may further include operations, features, means, or instructions for receiving control signaling indicating the zone identifier, where detecting the entering the geographic region may be based on receiving the control signaling indicating the zone identifier.

Some examples of the method, apparatuses, and non-transitory computer-readable medium described herein may further include operations, features, means, or instructions for detecting beam failure in one or more geographic regions corresponding to one or more respective zone identifiers and transmitting a report including an indication of the one or more respective zone identifiers, where receiving the control signaling indicating the zone identifier may be based on transmitting the report.

In some examples of the method, apparatuses, and non-transitory computer-readable medium described herein, detecting the triggering event may include operations, features, means, or instructions for determining that one or more parameters fail to satisfy a threshold during a time duration, where deactivating the functionality of the ML model may be based on the determining.

Some examples of the method, apparatuses, and non-transitory computer-readable medium described herein may further include operations, features, means, or instructions for receiving control signaling including an indication of the threshold and the time duration, where the determining may be based on receiving the control signaling including the indication of the threshold and the time duration.

Some examples of the method, apparatuses, and non-transitory computer-readable medium described herein may further include operations, features, means, or instructions for transmitting a report indicating that the one or more parameters fail to satisfy the threshold during the time duration.

In some examples of the method, apparatuses, and non-transitory computer-readable medium described herein, the one or more parameters include a block error rate, a reference signal receive power, a throughput value, or any combination thereof.

A method for wireless communications at a network entity is described. The method may include performing wireless communications using a functionality of a ML model used to maintain a wireless communications link with a UE, determining that the UE has deactivated a functionality of the ML model based on a triggering event, and continuing to perform wireless communications based on the determining.

An apparatus for wireless communications at a network entity is described. The apparatus may include a processor, memory coupled with the processor, and instructions stored in the memory. The instructions may be executable by the processor to cause the apparatus to perform wireless communications using a functionality of a ML model used to maintain a wireless communications link with a UE, determine that the UE has deactivated a functionality of the ML model based on a triggering event, and continue to perform wireless communications based on the determining.

Another apparatus for wireless communications at a network entity is described. The apparatus may include means for performing wireless communications using a functionality of a ML model used to maintain a wireless communications link with a UE, means for determining that the UE has deactivated a functionality of the ML model based on a triggering event, and means for continuing to perform wireless communications based on the determining.

A non-transitory computer-readable medium storing code for wireless communications at a network entity is described. The code may include instructions executable by a processor to perform wireless communications using a functionality of a ML model used to maintain a wireless communications link with a UE, determine that the UE has deactivated a functionality of the ML model based on a triggering event, and continue to perform wireless communications based on the determining.

Some examples of the method, apparatuses, and non-transitory computer-readable medium described herein may further include operations, features, means, or instructions for transmitting control signaling including an indication of the triggering event, where determining that the UE may have deactivated the functionality of the ML model may be based on transmitting the control signaling including the indication of the triggering event.

Some examples of the method, apparatuses, and non-transitory computer-readable medium described herein may further include operations, features, means, or instructions for receiving a deactivation report including an indication that the UE may have deactivated the functionality of the ML model, where the determining may be based on receiving the deactivation report.

In some examples of the method, apparatuses, and non-transitory computer-readable medium described herein, the triggering event includes a beam failure.

Some examples of the method, apparatuses, and non-transitory computer-readable medium described herein may further include operations, features, means, or instructions for transmitting control signaling corresponding to a beam failure recovery procedure, the control signaling including an indication of a beam failure detection timer, a block error rate threshold, and a threshold quantity of beam failure instances, where the determining may be based on transmitting the control signaling corresponding to the beam failure recovery procedure.

Some examples of the method, apparatuses, and non-transitory computer-readable medium described herein may further include operations, features, means, or instructions for transmitting control signaling indicating event parameters to use to activate or deactivate the functionality of the ML model, the control signaling including an indication of a value of a beam failure detection timer, a value of a block error rate threshold, and a value of a threshold quantity of beam failure instances that may be associated with activating or deactivating the functionality of the ML model, where deactivating the functionality of the ML model may be based on transmitting the control signaling.

Some examples of the method, apparatuses, and non-transitory computer-readable medium described herein may further include operations, features, means, or instructions for receiving, based on transmitting the control signaling corresponding to the functionality of the machine-learning model, an indication that the functionality of the ML model may have been deactivated, where the determining may be based on receiving the indication that the functionality of the ML model may have been deactivated.

Some examples of the method, apparatuses, and non-transitory computer-readable medium described herein may further include operations, features, means, or instructions for transmitting control signaling indicating a zone identifier corresponding to deactivation of the functionality of the ML model and receiving a report including an indication that the UE may have entered a geographic area corresponding to the zone identifier, where the determining may be based on receiving the indication that the UE may have entered the geographic area.

Some examples of the method, apparatuses, and non-transitory computer-readable medium described herein may further include operations, features, means, or instructions for receiving, from a set of multiple UEs, a set of multiple reports including indications of one or more respective zone identifiers including the zone identifier, the one or more respective zone identifiers corresponding to geographic locations corresponding to deactivation of the functionality of the ML model, where transmitting the control signaling indicating the zone identifier may be based on the set of multiple reports.

Some examples of the method, apparatuses, and non-transitory computer-readable medium described herein may further include operations, features, means, or instructions for receiving control signaling including an indication of a threshold and a time duration, where the determining may be based on receiving the control signaling including the indication of the threshold and the time duration.

In some examples of the method, apparatuses, and non-transitory computer-readable medium described herein, the triggering event includes one or more parameters failing to satisfy a threshold during a time duration.

Some examples of the method, apparatuses, and non-transitory computer-readable medium described herein may further include operations, features, means, or instructions for transmitting control signaling including an indication of the threshold and the time duration, where the determining may be based on transmitting the control signaling including the indication of the threshold and the time duration.

Some examples of the method, apparatuses, and non-transitory computer-readable medium described herein may further include operations, features, means, or instructions for receiving a report indicating that the one or more parameters fail to satisfy the threshold during the time duration, where the determining may be based on receiving the report.

In some examples of the method, apparatuses, and non-transitory computer-readable medium described herein, the one or more parameters include a block error rate, a reference signal receive power, a throughput value, or any combination thereof.

### BRIEF DESCRIPTION OF THE DRAWINGS

FIG. 1 shows an example of a wireless communications system that supports event-triggered activation and deactivation of machine learning (ML) functionality in accordance with one or more aspects of the present disclosure.

FIG. 2 shows an example of a wireless communications system that supports event-triggered activation and deactivation of ML functionality in accordance with one or more aspects of the present disclosure.

FIG. 3 shows an example of a process flow that supports event-triggered activation and deactivation of ML functionality in accordance with one or more aspects of the present disclosure.

FIGS. 4 and 5 show block diagrams of devices that support event-triggered activation and deactivation of ML functionality in accordance with one or more aspects of the present disclosure.

FIG. 6 shows a block diagram of a communications manager that supports event-triggered activation and deactivation of ML functionality in accordance with one or more aspects of the present disclosure.

FIG. 7 shows a diagram of a system including a device that supports event-triggered activation and deactivation of ML functionality in accordance with one or more aspects of the present disclosure.

FIGS. 8 and 9 show block diagrams of devices that support event-triggered activation and deactivation of ML functionality in accordance with one or more aspects of the present disclosure.

FIG. 10 shows a block diagram of a communications manager that supports event-triggered activation and deactivation of ML functionality in accordance with one or more aspects of the present disclosure.

FIG. 11 shows a diagram of a system including a device that supports event-triggered activation and deactivation of ML functionality in accordance with one or more aspects of the present disclosure.

FIGS. 12 through 17 show flowcharts illustrating methods that support event-triggered activation and deactivation of ML functionality in accordance with one or more aspects of the present disclosure.

### DETAILED DESCRIPTION

A user equipment (UE) may support artificial intelligence (AI) or machine-learning (ML) procedures to (AI/ML procedures) to perform one or more aspects of wireless communications and support communication via a wireless communication link. For instance, the UE may perform beam prediction and selection using AI or ML (e.g., may perform measurements via one set of beams, and may select another set of beams for wireless communications based on the measurements and the AI/ML).

However, in some scenarios, the AI/ML procedures may not function (e.g., may result in one or more failures or degraded communications that do not satisfy a threshold).

Without a mechanism to determine when to activate or deactivate various AI/ML functionalities or models, the UE may utilize AI/MI procedures in non-preferred scenarios, or the network entity may incorrectly assume that the UE is utilizing AI/ML functionalities or models. In such cases, resources may be improperly assigned or may remain under-utilized, or various wireless communications may fail (e.g., beam selection or reselection, beam failure recovery, among other examples), resulting in decreased throughput, inefficient use of system resources, increased system latency, and decreased user experience.

According to techniques described herein, the network entity may configure the UE to activate or deactivate AI/ML functionality (e.g., or AI/ML models) based on one or more triggering events taking place. The network entity may indicate the triggering events via configuration information. In some examples, the triggering events may be defined in one or more standards documents. In some examples, the triggering event may be a beam failure detection. For temporal and spatial domain beam prediction cases, the UE may detect a beam failure, and may fall back to non-AI/ML functionality (e.g., may perform beam detection without relying on AI or ML). Such procedures may be based on configuration from the network entity, or may be defined as a rule in one or more standards documents, or a combination thereof. In some examples, the triggering event may be detecting that the UE has entered a geographic location corresponding to a particular zone identifier (zone ID). In some examples, the triggering event may be based on one or more parameters satisfying a threshold.

Aspects of the disclosure are initially described in the context of wireless communications systems and process flows. Aspects of the disclosure are further illustrated by and described with reference to apparatus diagrams, system diagrams, and flowcharts that relate to event-triggered activation and deactivation of machine learning (ML) functionality.

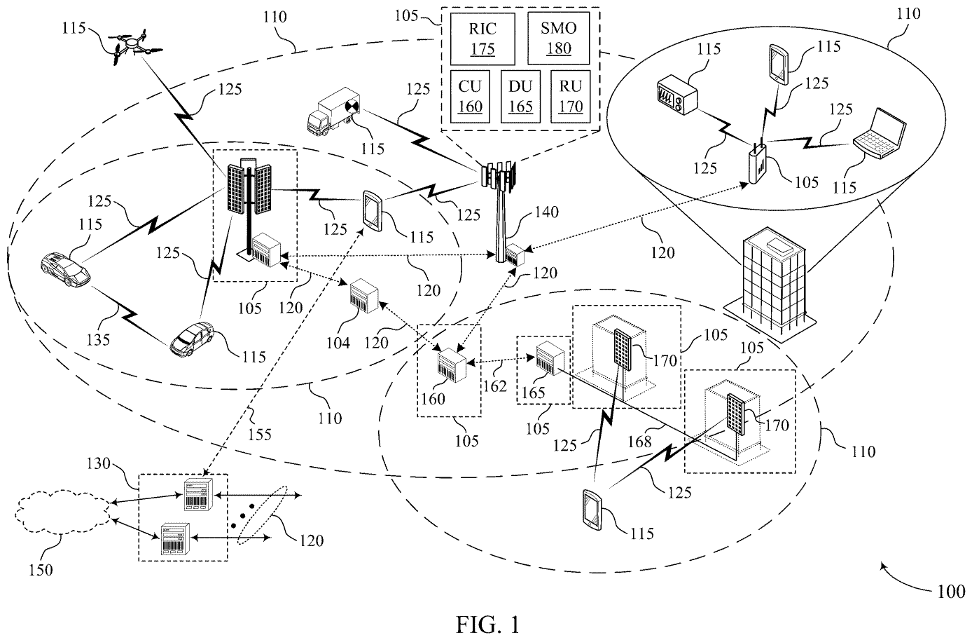

FIG. 1 shows an example of a wireless communications system 100 that supports event-triggered activation and deactivation of ML functionality in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU

### (vcu), a Virtual Du (vdu), a Virtual Ru (vru)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN.

Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104.

Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support event-triggered activation and deactivation of ML functionality as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, the network entity 105 may configure the UE 115 to activate or deactivate AI/ML functionality (e.g., or AI/ML models) based on one or more triggering events taking place. The network entity 105 may indicate the triggering events via configuration information. In some examples, the triggering events may be defined in one or more standards documents. In some examples, the triggering event may be a beam failure detection. For temporal and spatial domain beam prediction cases, the UE 115 may detect a beam failure, and may fall back to non-AI/ML functionality (e.g., may perform beam detection without relying on AI or ML). Such procedures may be based on configuration from the network entity, or may be defined as a rule in one or more standards documents, or a combination thereof. In some examples, the triggering event may be detecting that the UE 115 has entered a geographic location corresponding to a particular ID). In some examples, the triggering event may be based on one or more parameters satisfying a threshold.

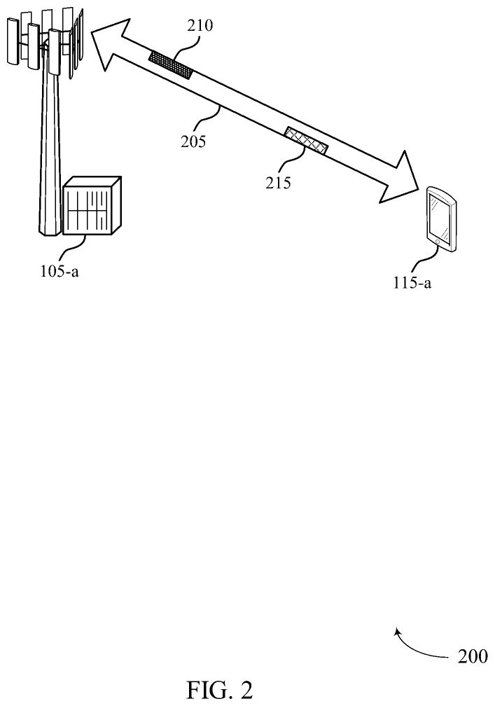

FIG. 2 shows an example of a wireless communications system 200 that supports event-triggered activation and deactivation of ML functionality in accordance with one or more aspects of the present disclosure. The wireless communications system 200 may implement aspects of, or be implemented by aspects of, the wireless communications system 100. For example, the wireless communications system 200 may include a network entity 105-a and a UE 115-a, which may be examples of corresponding devices described with reference to FIG. 1.

The UE 115-a and the network entity 105-a may communicate with each other via a wireless communication link 205. In some examples, the UE 115-a may enter a radio resource control (RRC) idle state or RRC inactive state. Upon exiting the RRC idle state or inactive state, the UE 115-a may perform initial access (e.g., a synchronization signal block (SSB) beam (e.g., wide beam) sweeping). The UE 115-a may successfully perform initial access, and ay perform beam management in an RRC connected state. Beam management may include beam prediction to identify and utilize beams without experience a beam failure or a link failure via the selected beams. If the UE experience a beam failure detection based on one or more measurements, the UE may perform beam failure recovery.

Beam management in an RRC connected state may include receiving one or more reference signals for measurement and reporting (e.g., SSBs, CSI-RSs, SRSs, etc.), channel quality reporting (e.g., reference signal receive power (RSRP) reporting), and TCI state configuration and indications (e.g., beam selection, configuration, and use). Beam management may also include SINR reporting, overhead and latency reduction e.g., CC group beam updates, faster uplink beam updates, etc.). In some examples, beam management may include efficiency enhancements, including unified TCI states, layer 1 or layer 2 centric mobility, dynamic TCI updates, uplink multi-panel use and selection, MPE mitigation, or the like. Beam management may also be applied to multi-transmission reception point (mTRP) scenarios.

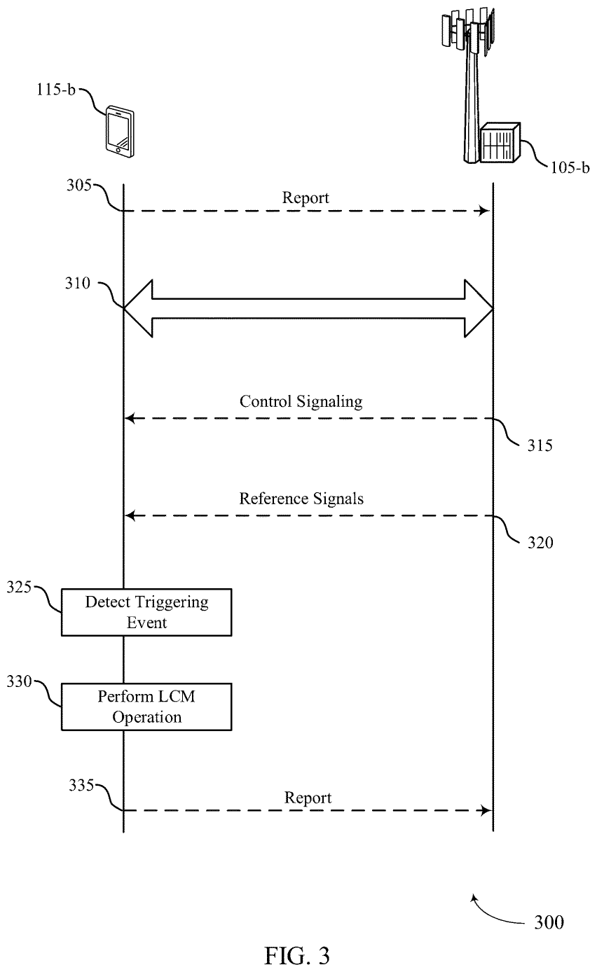

In the case of beam failure recovery, the UE 115-a may perform beam failure detection, and beam failure recovery for various cells (e.g., primary cell (PCell, primary secondary cell (PSCell), which may include beam failure detection via beam failure detection reference signals and physical downlink control channel (PDCCH) block error rate (BLER) as described in greater detail with reference to FIG. 3. For a secondary cell (SCell), the UE may perform beam failure detention similar to such procedure for an SCell. The UE 115-a may transmit a scheduling request (SR), or a media access control (MAC) control element (CE) based on the beam failure request for the SCell.

In some examples, the UE 115-a may support artificial intelligence (AI) or machine-learning (ML) procedures (AI/ML) for air-interface corresponding to various target use cases regarding aspects of communications such as performance, complexity, etc. For example, use cases may include beam management (e.g., beam prediction in time and/or spatial domain for overhead and latency reduction, beam selection accuracy improvement) among other examples. AI/ML approaches to various use cases or sub use cases may be divers enough to support various procedures and collaborations between the UE 115-a and the network entity 105-a. AI/ML models may support common and specific characteristics in various frameworks, including lifecycle management of AI/ML models (e.g., model training, model deployment, model interference, model monitoring, and model updating, among other examples).

In some examples, the UE 115-a and the network entity 105-a may perform beam management or beam selection using AI/ML models or functionalities. For instance, for AI/ML based beam management, the UE 115-a may support a first case (e.g., beam management (BM) case 1) and a second case (BM case 2). In BM case 1, the UE 115-a may perform spatial domain downlink beam prediction for a first set of beams (e.g., set A) based on measurement results of a second set of beams (e.g., set B). In BM case 2, the UE 115-a may perform temporal domain downlink beam prediction for a first set of beams (e.g., set A) based on measurement results of a second set of beams (e.g., set B). Set A and Set B may be in the same frequency range, or different frequency range. The UE 115-a may perform actual measurement for one or more beams (e.g., set B), and may use AI/ML models to predict a second set of beams (e.g., set A) for communications via the communication link 205.

In some examples, the UE 115-a may perform one or more life-cycle management (LCM) operations (e.g., decisions) for an AI/ML model or functionality. LCM operations may be based at least in part on the basis that an AIML model has a model identifier (ID) with associated information, or model functionality at least for some AI/ML operations/procedures. Model IDs may be associated with information and/or model functionality. Usage of model IDs with associated information or model functionality may be based on LCM procedures. In some examples, for UE-side models, or for functionality-based LCM procedures, indications of activation of LCM operations (e.g., activation, deactivation, switching, or fallback behaviors for a given AI/ML) for an AI/ML functionality or AI/ML ID may be exchanged between the network entity 105-a and the UE 115-a. For Model-ID based LCM operations, the UE 115-a and the network entity 105-a may indicate LCM operations such as model selection, activation, deactivation, switching, of fallback procedures, based on individual model IDs.

LCM methodologies may include functionality-based LCM operations. In such examples, the network entity 105-a may be aware of (e.g., may have access to information regarding) AI/ML functionality at the UE 115-a via UE capability reporting.. The UE 115-a may report its capability to support one or more AI/ML functionalities (e.g., beam prediction, beam management, channel prediction, mobility operations, among other examples). Each AI/ML functionality may correspond to a reference signal configuration from the network entity, and one or more AI/ML IDs (e.g., a single AI/ML model with a first AI/ML model ID may correspond to a low-doppler beam prediction AI/ML functionality, and a second AI/ML model with a second AI/ML model ID may correspond to a high-doppler beam prediction of the same AI/ML functionality). During an inference phase of the AI/ML functionality, the network entity 105-a may control AI/ML functionality at the UE 115-a. For example, the network entity 105-a may instruct the UE 115-a to perform one or more LCM operations (e.g., activate, deactivate, switch, default, among other examples) for a reported AI/ML functionality. The controlling may refer to functionality selection, activation, deactivation, switching, falling back, or monitoring, among other examples.

LCM methodologies may include model ID based LCM operations. In such examples, AI/ML models are registered at the network entity 105 with mode IDs. For example, the network entity 105-a may configure, or the UE 115-a may report, an indication of one or more model IDs supported by the UE 115-a. The model IDs may or may not correspond to AI/ML functionalities. The network entity 105-a may be aware of (e.g., have access to information regarding) the model IDs supported by the UE 115-a based on capability signaling from the UE 115-a (e.g., indicating which AI/ML model IDs the UE 115-a supports).

The UE may have one AI/ML model for a given AI/ML functionality, or may have multiple AI/ML models for the functionality. Functionalities may be indicated via identifiers (IDs), or by name or term, or may be defined via a table, bitmap, or other indication (e.g., and may be indicated via signaling or defined in one or more standards, or a combination thereof).

Both model ID based and functionality based LCM management methodologies may result in implications in terms of phases of ML workflow, and including data collection, interference, and model monitoring, as described herein.

In some examples, AI/ML functionalities or models may be activated or deactivated based on rules or triggering events. Such rules or triggering events may be defined in one or more standards, or may be indicated to the UE 115-a. In some examples, triggering conditions may be related to beam failure detection and beam failure indications, as described in greater detail with reference to FIG. 3. For example, The UE 115-a may perform beam failure detection and beam failure recovery procedures based on monitoring periodic beam failure detection reference signals (BFD-RSs) (e.g., via the physical layer). BFD-RSs may be, for example, CSI-RSs, or SSBs, among other examples. The UE 115-a may detect a beam failure instance (BFI) indicator at every occasion of a BFD-RS. For example, the UE 115-a may determine if an estimated BLER is greater than a threshold. If the estimated BLER is greater than the threshold, then the UE 115-a may detect a BFI. If the estimated BLER is not greater than the threshold, then the UE 115-a may determine that there is not a BFI. At the first indication of a BFI, the UE 115-a may initiate a BFD timer. With each BFI indicator, the UE 115-a (e.g., a MAC layer at the UE 115-a) may increase a BFI counter by one. If a total BFI count reaches a threshold quantity of BFIs (e.g., a maxCount threshold) before the BFD timer expires, then the UE 115-a may determine (e.g., declare or report) that the beam failure has occurred for a current set of one or more beams corresponding to the wireless communication link 205. In such examples, the UE 115-a may initiate a beam failure recovery (BFR) procedure. If the BFD timer expires before a total BFI count reaches the maxCount threshold, the UE 115-a may not determine a beam failure, and the total BFI count may be rest to 0 and the BFD timer may be reset. The network entity 105-a may configure the BFD timer, the threshold, etc. (e.g., via an RRC message including an information element (IE) such as a RadioLinkMonitoringConfig IE including beamFailureDetectionTimer and beamFailureInstanceMaxCount).

The UE 115-a may use AI/ML procedures to perform one or more aspects of wireless communications and support communication via the wireless communication link 205. For instance, the UE 115-a may perform beam prediction and selection using AI or ML (e.g., may perform measurements via one set of beams, and may select another set of beams for wireless communications based on the measurements and the AI/ML. However, in some scenarios, the AI/ML procedures may not function (e.g., may result in one or more failures or degraded communications that do not satisfy a threshold). Without a mechanism to determine when to activate or deactivate various AI/ML functionalities or models, the UE 115-a may utilize AI/MI procedures in non-preferred scenarios, or the network entity 105-a may incorrectly assume that the UE 115-a is utilizing AI/ML functionalities or models. In such cases, resources may be improperly assigned or may remain under-utilized, various wireless communications may fail (e.g., beam selection or reselection, beam failure recovery, among other examples), resulting in decreased throughput, inefficient use of system resources, increased system latency, and decreased user experience.

According to techniques described herein, the network entity 105-a may configure the UE 115-a to activate or deactivate AI/ML functionality (e.g., or AI/ML models) based on one or more triggering events occurring. The network entity 105-a may indicate the triggering events via configuration information 210. In some examples, the triggering events may be defined in one or more standards documents.

In some examples, the triggering event may be a beam failure detection. For temporal and spatial domain beam prediction cases, the UE 115-a may detect a beam failure, and may fall back to non-AI/ML functionality (e.g., may perform beam detection without relying on AI or ML). Such procedures may be based on configuration from the network entity 105-a, or may be defined as a rule in one or more standards documents, or a combination thereof.

In some examples, the triggering event may be a beam failure detection based on parameters configured for beam failure detection. For example, the UE 115-a may reuse the configuration for beam failure detection as a triggering event for AI/ML LCM operations. For instance, the network entity may configure the UE with a BFD-RS configuration, estimated BLER threshold, BFD timer (e.g., as indicated by an RRC information element including a beamFailureDetectionTimer), a threshold quantity of beam failure instances (e.g., beamFailureInstanceMaxCount), for beam failure detection (e.g., via configuration information 210). The UE 115-a may then perform an LCM operation (e.g., activate or deactivate an AI/ML functionality, switch from a first AI/ML functionality to another AI/ML functionality, default to or from an AI/ML functionality, monitor, among other examples) based on the detected beam failure. In some examples, the UE 115-a may transmit a beam failure indication report to the network entity 105-a. The report may serve as an implicit indication that the UE 115-a has performed the LCM operation (e.g., activated or deactivated an AI/ML functionality), without a further explicit indication that the Ai/ML functionality is being activated or deactivated (e.g., the network entity 105-a may implicitly determine the LCM operation performed by the UE 115-a based on the rules or triggering events defined in the configuration information 210).

In some examples, the triggering event may be a beam failure detection based on parameters configured specifically for triggering of LCM operations. For example, the network entity 105-a may indicate (e.g., in configuration information 210) separate configuration defined with reference to the triggering condition for the LCM operations. For example, the network entity 105-a may configure a first set of parameters (e.g., a BFD-RS configuration, estimated BLER threshold, BFD timer a threshold quantity of beam failure instances, for beam failure detection), and a second set of parameters (e.g., a BFD-RS configuration, estimated BLER threshold, BFD timer, a threshold quantity of beam failure instances) for event-triggered LCM operations. In some cases, at least some of the first set of parameters and/or the second set of parameters may be indicated by an RRC information element including a beamFailureDetectionTimer. In some cases, a threshold quantity of beam failure instances may be indicated by beamFailureInstanceMaxCount. The second set of parameters and threshold may be more or less stringent than the second set of parameters and thresholds. For instance, in the case where the second set of parameters for event triggered LCM operations is more stringent than the first set of parameters, the UE 115-a may detect the triggering condition (e.g., a quantity of BFIs occurring within a timer satisfies a configured threshold of the second set of parameters), and may perform the LCM operation based thereon (e.g., without detecting a beam failure or reporting the beam failure). In some examples, the UE 115-a may transmit a report indication that the AI/ML functionality has been activated or deactivated (e.g., via a report 215) because signaling implications between the network entity 105-a and the UE 115-a. Subsequently, in some examples (e.g., and distinct form the triggering event), the UE 115-a may determine a beam failure, and may report the beam failure according to the first set of parameters.

In some examples, the triggering event may be detecting that the UE 115-a has entered a geographic location corresponding to a particular zone identifier (zone ID). Based on statistical data gathered historically (e.g., from other UEs 115 in similar conditions or similar devices), the network entity 105-a may configure the UE 115-a (e.g., via the configuration information 210) to perform an LCM operation (e.g., activate or deactivate an AI/ML functionality) based on entering the zone ID or multiple ozone IDs configured by the network entity 105-a. For example, the network entity 105-a may identify (e.g., based on reporting from multiple UEs 115) that one or more zone IDs close to or on a cell edge, or one or more zone IDs in an urban environment with a high probability of blockages, etc. The network entity 105-a may indicate (e.g., via the configuration information 210) the identified zone IDs, and may indicate that the UE 115-a is to perform an LCM operation (e.g., deactivate an AI/ML functionality, such as beam prediction) if the UE 115-a enters the indicated zone IDs. Similarly, the network entity 105-a may indicate that the UE 115-a is to deactivate an AI/ML functionality upon entering a zone ID corresponding to an indoor environment, or an outdoor environment, among other examples.

In some examples, the triggering event may be based on one or more other parameters. For example, if a given parameter (e.g., throughput, BLER, L1-RSRP, among other examples) of a serving beam corresponding to the wireless communication link 205 fails to satisfy a threshold (e.g., is lower than a threshold) for more than a configured time duration, the network entity 105-a may configure the UE 115-a (e.g., via the configuration information 210) to perform an LCM operation (e.g., deactivate an AI/ML functionality). The parameter and the corresponding threshold, time duration, etc., may be configured by the network entity 105-a (e.g., via the configuration information 210). In some examples, the functionality may depend on one or more conditions. A subset of functionalities may be valid based on other conditions. Such conditions may be configured at the UE 115-a, or may be defined in one or more standards.

FIG. 3 shows an example of a process flow 300 that supports event-triggered activation and deactivation of ML functionality in accordance with one or more aspects of the present disclosure. The process flow may implement aspects of, or be implemented by aspects of, the wireless communications system 100 and the wireless communications system 200. For example, the process flow may include a UE 115-b and a network entity 105-a, which may be examples of corresponding devices described with reference to FIGS. 1-2.

At 310, the UE 115-b may perform wireless communications (e.g., with the network entity 105-b) using a functionality of an ML model (e.g., an AI/ML functionality) used to maintain a wireless communications link.

At 325, the UE 115-b may detect a triggering event. The triggering event may be associated with an LCM operation (e.g., deactivation) of the functionality of the ML model. The triggering event may be defined in one or more standards. In some examples, the UE 115-b may receive control signaling at 315 indicating the triggering event (e.g., one or more zone IDs in which the UE 115-b is to deactivate the AI/ML functionality, a threshold and one or more parameters where the UE 115-b is to deactivate the AI/ML if current values for the one or more parameters do not satisfy the threshold, thresholds, timers, and counters for beam failure detection where the UE 115-b is to deactivate the AI/ML functionality if a beam failure is detected).

At 330, the UE 115-b may perform the LCM operation (e.g., may deactivate the functionality of the ML model based on the detecting at 325).

In some examples, the UE 115-b may transmit a deactivation report (e.g., at 335) to the network entity 105-b. The deactivation report may indicate (e.g., implicitly or explicitly) that the UE 115-b has deactivated the functionality at 330. The UE 115-b may subsequently continue to perform wireless communications via the link based on deactivating the functionality of the ML model.

In some examples, the triggering event may include a beam failure detection (e.g., as defined in one or more standards or as defined in the control signaling at 315). For example, at 320, the UE 115-b may monitor for one or more reference signals for beam failure (e.g., one or more BFD-RSs). The UE 115-b may initiate a beam failure detection timer based at least in part on the monitoring and detecting a first beam failure BLER threshold. The UE 115-b may detect the beam failure based on a quantity of beam failure instances occurring before expiration of the beam failure detection timer satisfying a threshold quantity.

The UE 115-b may receive the control signaling at 315, which may be specific to (e.g., correspond to) a beam failure recovery procedure. The control signaling may include an indication of the beam failure detection timer, the block error rate threshold, and the threshold quantity, and the UE 115-b may reuse the beam failure recovery parameters for detecting the triggering event (e.g., a beam failure defined by the control signaling may indicate a beam failure and may trigger deactivation of the AI/LM functionality). In response to detecting the beam failure, the UE 115-b may transmit a beam failure report (e.g., at 335) indicating the beam failure. In such examples, the report may serve as an implicit indicator to the network entity 105-b that the UE 115-b has deactivated the AI/ML functionality.

The UE 115-b nay receive control signaling at 315, which may be specific to (e.g., correspond to) activation or deactivation of the functionality of the ML model. The control signaling may include event parameters to use to activate or deactivate the functionality of the ML model, the control signaling including an indication of a value of a beam failure detection timer, a value of a block error rate threshold, and a value of a threshold quantity that are associated with activating or deactivating the functionality of the MLD model. In such examples, the UE 115-b may deactivate or activate the AI/ML functionality at 330 based on the event parameters (e.g., regardless of whether a beam failure is detected according to a beam failure detection or beam recovery procedure.

In some examples, the triggering event may include detecting that the UE 115-b has entered a geographic region associated with a zone ID, and the UE 115-b may deactivate or activate the functionality of the ML model based on detecting the entering. The UE 115-b may receive an indication of one or more zone IDs (e.g., the triggering conditions) via the control signaling at 315, which may indicate that the UE 115-b is to perform the LCM operation if the UE 115-b enters any of the indicated zone IDs. In some examples, the list of indicated zone IDs may be based on reports from multiple UEs 115 (e.g., including the UE 115-b). For example, at 305, the UE 115-b may detect one or more occurrences or conditions (e.g., a beam failure in one or more geographic regions in one or more zone IDs), and may transmit a report indicating the one or more respective zone IDs. The network entity may aggregate such information reported from multiple UEs to identify the zone IDs in which the UE 115-b is to deactivate the AI/ML functionality.

In some examples, the triggering event may include determining that one or more parameters fail to satisfy a threshold during a time duration, where deactivating the functionality of the ML model is based at least in part on the determining. The UE 115-b may receive, via the control signaling at 315, an indication of the threshold and the time duration. In some examples, the UE 115-b may transmit a report at 335 indicating that the one or more parameters fail to satisfy the threshold during the time duration. In some examples, the parameters may include a BLER, an RSRP, a throughput value, or any combination thereof.

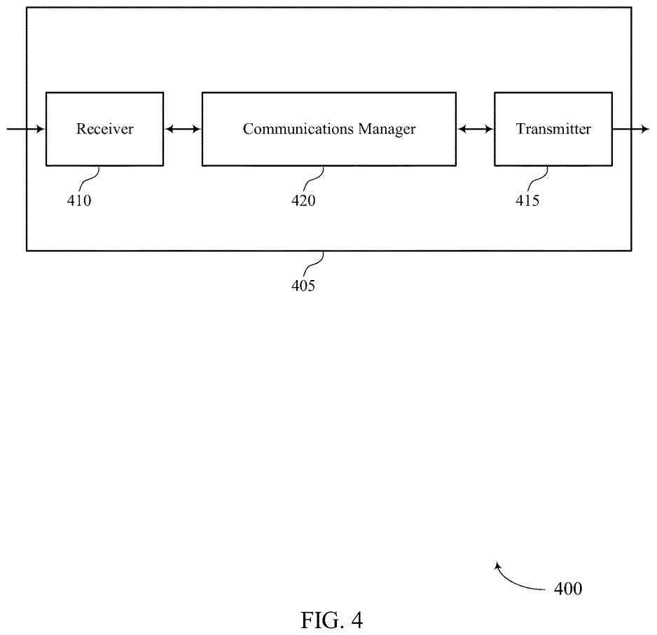

FIG. 4 shows a block diagram 400 of a device 405 that supports event-triggered activation and deactivation of ML functionality in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to event-triggered activation and deactivation of ML functionality).

Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to event-triggered activation and deactivation of ML functionality). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of event-triggered activation and deactivation of ML functionality as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 is capable of, configured to, or operable to support a means for performing wireless communications using a functionality of a ML model used to maintain a wireless communications link. The communications manager 420 is capable of, configured to, or operable to support a means for detecting a triggering event associated with deactivation of the functionality of the ML model. The communications manager 420 is capable of, configured to, or operable to support a means for deactivating the functionality of the ML model based on the detecting.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for event-triggered LCM operations resulting in improved reliability of wireless communications, decreased system latency, more efficient use of available system resources, improved throughput, and improved user experience.

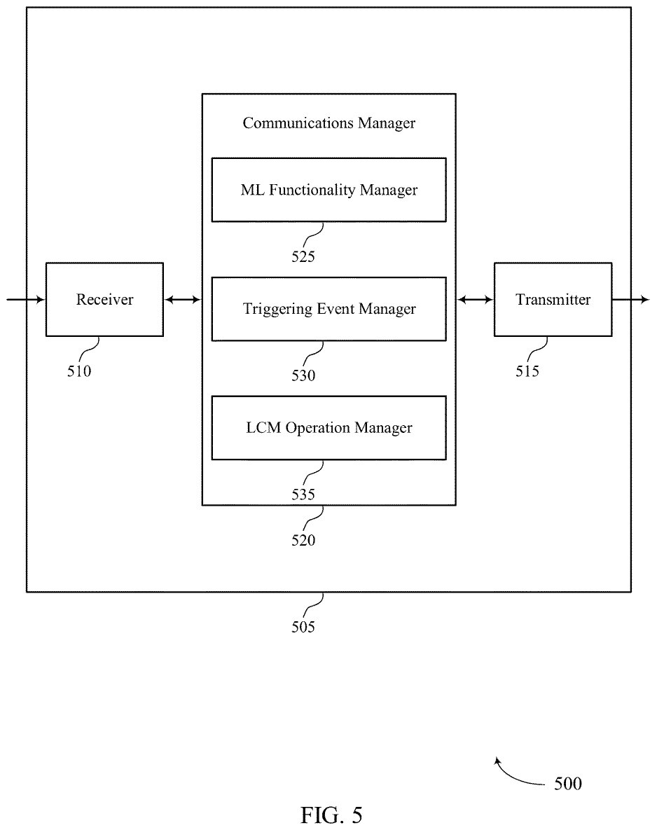

FIG. 5 shows a block diagram 500 of a device 505 that supports event-triggered activation and deactivation of ML functionality in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to event-triggered activation and deactivation of ML functionality). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to event-triggered activation and deactivation of ML functionality). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of event-triggered activation and deactivation of ML functionality as described herein. For example, the communications manager 520 may include an ML functionality manager 525, a triggering event manager 530, an LCM operation manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The ML functionality manager 525 is capable of, configured to, or operable to support a means for performing wireless communications using a functionality of a ML model used to maintain a wireless communications link. The triggering event manager 530 is capable of, configured to, or operable to support a means for detecting a triggering event associated with deactivation of the functionality of the ML model. The LCM operation manager 535 is capable of, configured to, or operable to support a means for deactivating the functionality of the ML model based on the detecting.

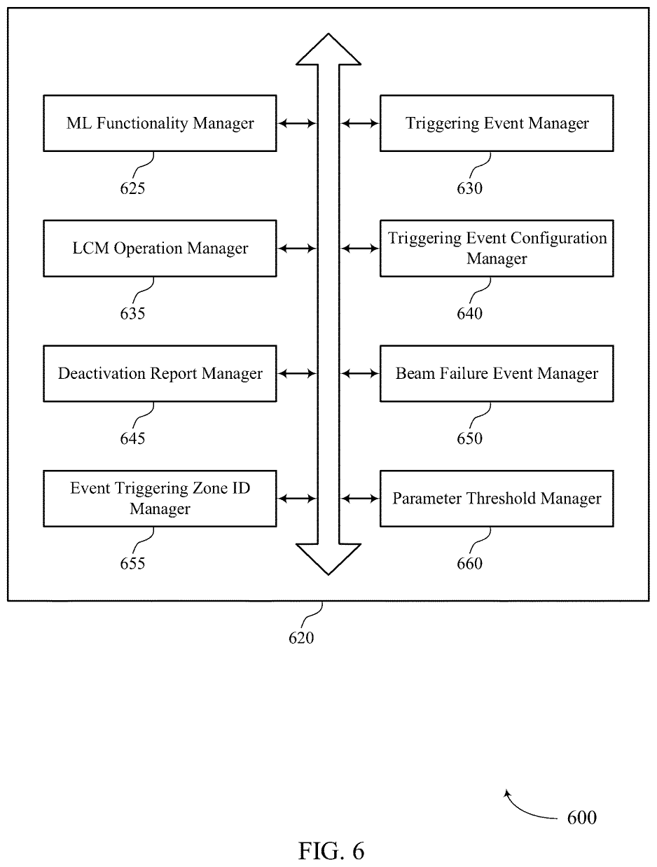

FIG. 6 shows a block diagram 600 of a communications manager 620 that supports event-triggered activation and deactivation of ML functionality in accordance with one or more aspects of the present disclosure. The communications manager 620 may be an example of aspects of a communications manager 420, a communications manager 520, or both, as described herein. The communications manager 620, or various components thereof, may be an example of means for performing various aspects of event-triggered activation and deactivation of ML functionality as described herein. For example, the communications manager 620 may include an ML functionality manager 625, a triggering event manager 630, an LCM operation manager 635, a triggering event configuration manager 640, a deactivation report manager 645, a beam failure event manager 650, an event triggering zone ID manager 655, a parameter threshold manager 660, or any combination thereof. Each of these components may communicate, directly or indirectly, with one another (e.g., via one or more buses).

The communications manager 620 may support wireless communications at a UE in accordance with examples as disclosed herein. The ML functionality manager 625 is capable of, configured to, or operable to support a means for performing wireless communications using a functionality of a ML model used to maintain a wireless communications link. The triggering event manager 630 is capable of, configured to, or operable to support a means for detecting a triggering event associated with deactivation of the functionality of the ML model. The LCM operation manager 635 is capable of, configured to, or operable to support a means for deactivating the functionality of the ML model based on the detecting.

In some examples, the triggering event configuration manager 640 is capable of, configured to, or operable to support a means for receiving control signaling including an indication of the triggering event, where detecting the triggering event is based on receiving the control signaling.

In some examples, the deactivation report manager 645 is capable of, configured to, or operable to support a means for transmitting a deactivation report including an indication that the UE has deactivated the functionality of the ML model.

In some examples, the deactivation report manager 645 is capable of, configured to, or operable to support a means for continuing to perform wireless communications via the wireless communications link based on deactivating the functionality of the ML model.

In some examples, to support detecting the triggering event, the beam failure event manager 650 is capable of, configured to, or operable to support a means for monitoring reference signals for one or more beam failures. In some examples, to support detecting the triggering event, the beam failure event manager 650 is capable of, configured to, or operable to support a means for initiating a beam failure detection timer based on the monitoring and detecting a first beam failure instance including a block error rate corresponding to a first reference signal failing to satisfy a block error rate threshold. In some examples, to support detecting the triggering event, the beam failure event manager 650 is capable of, configured to, or operable to support a means for detecting a beam failure based on a quantity of beam failure instances occurring before expiration of the beam failure detection timer satisfies a threshold quantity.

In some examples, the beam failure event manager 650 is capable of, configured to, or operable to support a means for receiving control signaling corresponding to a beam failure recovery procedure, the control signaling including an indication of the beam failure detection timer, the block error rate threshold, and the threshold quantity. In some examples, the beam failure event manager 650 is capable of, configured to, or operable to support a means for transmitting a beam failure report indicating the beam failure based on detecting the beam failure, where deactivating the functionality of the ML model is based on transmitting the beam failure report.

In some examples, the beam failure event manager 650 is capable of, configured to, or operable to support a means for receiving control signaling indicating event parameters to use to activate or deactivate the functionality of the ML model, the control signaling including an indication of a value of a beam failure detection timer, a value of a block error rate threshold, and a value of a threshold quantity that are associated with activating or deactivating the functionality of the ML model, where detecting the triggering event is based on the event parameters.

In some examples, to support detecting the triggering event, the event triggering zone ID manager 655 is capable of, configured to, or operable to support a means for detecting an entering into a geographic region associated with a zone identifier, where deactivating the functionality of the ML model is based on detecting the entering the geographic region.

In some examples, the event triggering zone ID manager 655 is capable of, configured to, or operable to support a means for receiving control signaling indicating the zone identifier, where detecting the entering the geographic region is based on receiving the control signaling indicating the zone identifier.

In some examples, the event triggering zone ID manager 655 is capable of, configured to, or operable to support a means for detecting beam failure in one or more geographic regions corresponding to one or more respective zone identifiers. In some examples, the event triggering zone ID manager 655 is capable of, configured to, or operable to support a means for transmitting a report including an indication of the one or more respective zone identifiers, where receiving the control signaling indicating the zone identifier is based on transmitting the report.

In some examples, to support detecting the triggering event, the parameter threshold manager 660 is capable of, configured to, or operable to support a means for determining that one or more parameters fail to satisfy a threshold during a time duration, where deactivating the functionality of the ML model is based on the determining.

In some examples, the parameter threshold manager 660 is capable of, configured to, or operable to support a means for receiving control signaling including an indication of the threshold and the time duration, where the determining is based on receiving the control signaling including the indication of the threshold and the time duration.

In some examples, the parameter threshold manager 660 is capable of, configured to, or operable to support a means for transmitting a report indicating that the one or more parameters fail to satisfy the threshold during the time duration.

In some examples, the one or more parameters include a block error rate, a reference signal receive power, a throughput value, or any combination thereof.

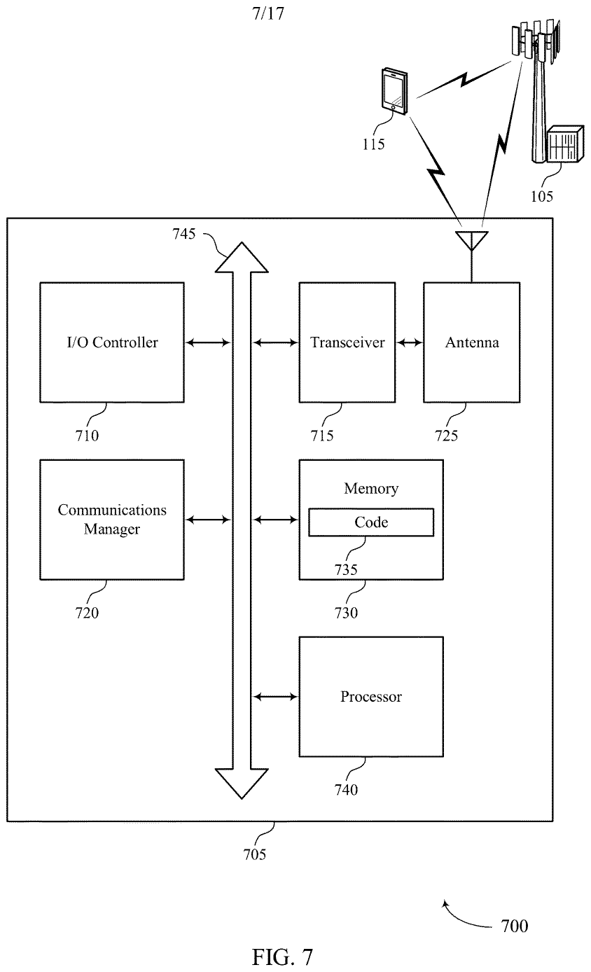

FIG. 7 shows a diagram of a system 700 including a device 705 that supports event-triggered activation and deactivation of ML functionality in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting event-triggered activation and deactivation of ML functionality). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 is capable of, configured to, or operable to support a means for performing wireless communications using a functionality of a ML model used to maintain a wireless communications link. The communications manager 720 is capable of, configured to, or operable to support a means for detecting a triggering event associated with deactivation of the functionality of the ML model. The communications manager 720 is capable of, configured to, or operable to support a means for deactivating the functionality of the ML model based on the detecting.

By including or configuring the communications manager 720 in accordance with examples as described herein, the device 705 may support techniques for event-triggered LCM operations resulting in improved reliability of wireless communications, decreased system latency, more efficient use of available system resources, improved throughput, and improved user experience.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of event-triggered activation and deactivation of ML functionality as described herein, or the processor 740 and the memory 730 may be otherwise configured to perform or support such operations.

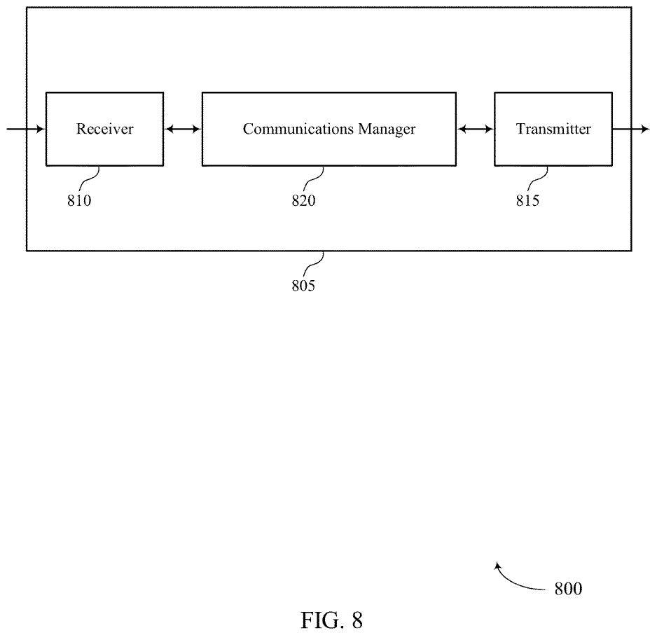

FIG. 8 shows a block diagram 800 of a device 805 that supports event-triggered activation and deactivation of ML functionality in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of event-triggered activation and deactivation of ML functionality as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 is capable of, configured to, or operable to support a means for performing wireless communications using a functionality of a ML model used to maintain a wireless communications link with a UE. The communications manager 820 is capable of, configured to, or operable to support a means for determining that the UE has deactivated a functionality of the ML model based on a triggering event. The communications manager 820 is capable of, configured to, or operable to support a means for continuing to perform wireless communications based on the determining.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for event-triggered LCM operations resulting in improved reliability of wireless communications, decreased system latency, more efficient use of available system resources, improved throughput, and improved user experience.

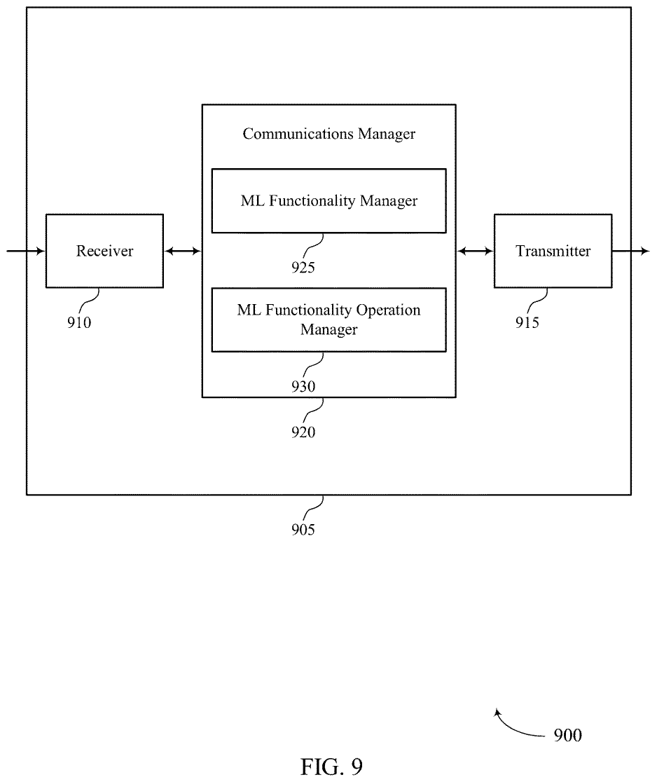

FIG. 9 shows a block diagram 900 of a device 905 that supports event-triggered activation and deactivation of ML functionality in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of event-triggered activation and deactivation of ML functionality as described herein. For example, the communications manager 920 may include an ML functionality manager 925 an ML functionality operation manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The ML functionality manager 925 is capable of, configured to, or operable to support a means for performing wireless communications using a functionality of a ML model used to maintain a wireless communications link with a UE. The ML functionality operation manager 930 is capable of, configured to, or operable to support a means for determining that the UE has deactivated a functionality of the ML model based on a triggering event. The ML functionality operation manager 930 is capable of, configured to, or operable to support a means for continuing to perform wireless communications based on the determining.

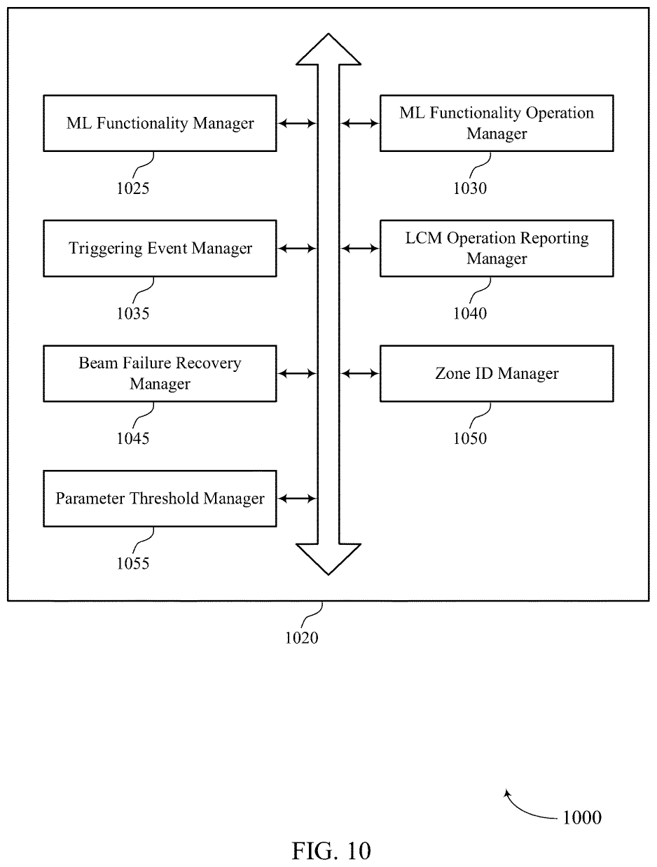

FIG. 10 shows a block diagram 1000 of a communications manager 1020 that supports event-triggered activation and deactivation of ML functionality in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of event-triggered activation and deactivation of ML functionality as described herein. For example, the communications manager 1020 may include an ML functionality manager 1025, an ML functionality operation manager 1030, a triggering event manager 1035, an LCM operation reporting manager 1040, a beam failure recovery manager 1045, a zone ID manager 1050, a parameter threshold manager 1055, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The ML functionality manager 1025 is capable of, configured to, or operable to support a means for performing wireless communications using a functionality of a ML model used to maintain a wireless communications link with a UE. The ML functionality operation manager 1030 is capable of, configured to, or operable to support a means for determining that the UE has deactivated a functionality of the ML model based on a triggering event. In some examples, the ML functionality operation manager 1030 is capable of, configured to, or operable to support a means for continuing to perform wireless communications based on the determining.

In some examples, the triggering event manager 1035 is capable of, configured to, or operable to support a means for transmitting control signaling including an indication of the triggering event, where determining that the UE has deactivated the functionality of the ML model is based on transmitting the control signaling including the indication of the triggering event.

In some examples, the LCM operation reporting manager 1040 is capable of, configured to, or operable to support a means for receiving a deactivation report including an indication that the UE has deactivated the functionality of the ML model, where the determining is based on receiving the deactivation report.

In some examples, the triggering event includes a beam failure.

In some examples, the beam failure recovery manager 1045 is capable of, configured to, or operable to support a means for transmitting control signaling corresponding to a beam failure recovery procedure, the control signaling including an indication of a beam failure detection timer, a block error rate threshold, and a threshold quantity of beam failure instances, where the determining is based on transmitting the control signaling corresponding to the beam failure recovery procedure.

In some examples, the beam failure recovery manager 1045 is capable of, configured to, or operable to support a means for transmitting control signaling indicating event parameters to use to activate or deactivate the functionality of the ML model, the control signaling including an indication of a value of a beam failure detection timer, a value of a block error rate threshold, and a value of a threshold quantity of beam failure instances that are associated with activating or deactivating the functionality of the ML model, where deactivating the functionality of the ML model is based on transmitting the control signaling.

In some examples, the beam failure recovery manager 1045 is capable of, configured to, or operable to support a means for receiving, based on transmitting the control signaling corresponding to the functionality of the ML model, an indication that the functionality of the ML model has been deactivated, where the determining is based on receiving the indication that the functionality of the ML model has been deactivated.

In some examples, the zone ID manager 1050 is capable of, configured to, or operable to support a means for transmitting control signaling indicating a zone identifier corresponding to deactivation of the functionality of the ML model. In some examples, the zone ID manager 1050 is capable of, configured to, or operable to support a means for receiving a report including an indication that the UE has entered a geographic area corresponding to the zone identifier, where the determining is based on receiving the indication that the UE has entered the geographic area.

In some examples, the zone ID manager 1050 is capable of, configured to, or operable to support a means for receiving, from a set of multiple UEs, a set of multiple reports including indications of one or more respective zone identifiers including the zone identifier, the one or more respective zone identifiers corresponding to geographic locations corresponding to deactivation of the functionality of the ML model, where transmitting the control signaling indicating the zone identifier is based on the set of multiple reports.

In some examples, the parameter threshold manager 1055 is capable of, configured to, or operable to support a means for receiving control signaling including an indication of a threshold and a time duration, where the determining is based on receiving the control signaling including the indication of the threshold and the time duration.

In some examples, the triggering event includes one or more parameters failing to satisfy a threshold during a time duration.

In some examples, the parameter threshold manager 1055 is capable of, configured to, or operable to support a means for transmitting control signaling including an indication of the threshold and the time duration, where the determining is based on transmitting the control signaling including the indication of the threshold and the time duration.

In some examples, the parameter threshold manager 1055 is capable of, configured to, or operable to support a means for receiving a report indicating that the one or more parameters fail to satisfy the threshold during the time duration, where the determining is based on receiving the report.

In some examples, the one or more parameters include a block error rate, a reference signal receive power, a throughput value, or any combination thereof.

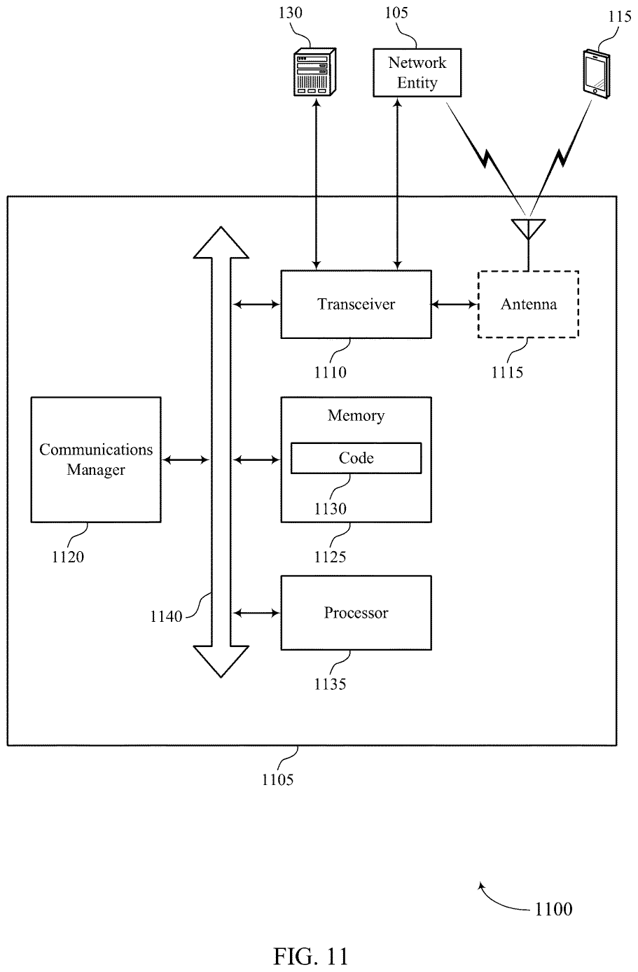

FIG. 11 shows a diagram of a system 1100 including a device 1105 that supports event-triggered activation and deactivation of ML functionality in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting event-triggered activation and deactivation of ML functionality). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 is capable of, configured to, or operable to support a means for performing wireless communications using a functionality of a ML model used to maintain a wireless communications link with a UE. The communications manager 1120 is capable of, configured to, or operable to support a means for determining that the UE has deactivated a functionality of the ML model based on a triggering event. The communications manager 1120 is capable of, configured to, or operable to support a means for continuing to perform wireless communications based on the determining.

By including or configuring the communications manager 1120 in accordance with examples as described herein, the device 1105 may support techniques for event-triggered LCM operations resulting in improved reliability of wireless communications, decreased system latency, more efficient use of available system resources, improved throughput, and improved user experience.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of event-triggered activation and deactivation of ML functionality as described herein, or the processor 1135 and the memory 1125 may be otherwise configured to perform or support such operations.

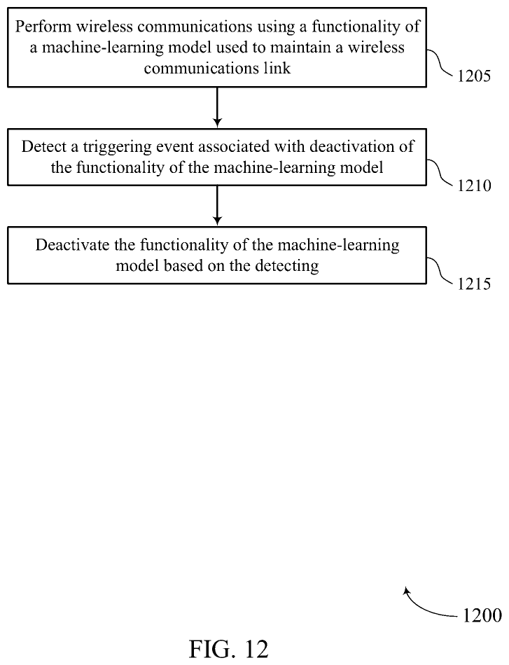

FIG. 12 shows a flowchart illustrating a method 1200 that supports event-triggered activation and deactivation of ML functionality in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the wireless UE to perform the described functions. Additionally, or alternatively, the wireless UE may perform aspects of the described functions using special-purpose hardware.

At 1205, the method may include performing wireless communications using a functionality of a ML model used to maintain a wireless communications link. The operations of 1205 may be performed in accordance with examples as disclosed herein. In some examples, aspects of the operations of 1205 may be performed by an ML functionality manager 625 as described with reference to FIG. 6.

At 1210, the method may include detecting a triggering event associated with deactivation of the functionality of the ML model. The operations of 1210 may be performed in accordance with examples as disclosed herein. In some examples, aspects of the operations of 1210 may be performed by a triggering event manager 630 as described with reference to FIG. 6.

At 1215, the method may include deactivating the functionality of the ML model based on the detecting. The operations of 1215 may be performed in accordance with examples as disclosed herein. In some examples, aspects of the operations of 1215 may be performed by an LCM operation manager 635 as described with reference to FIG. 6.

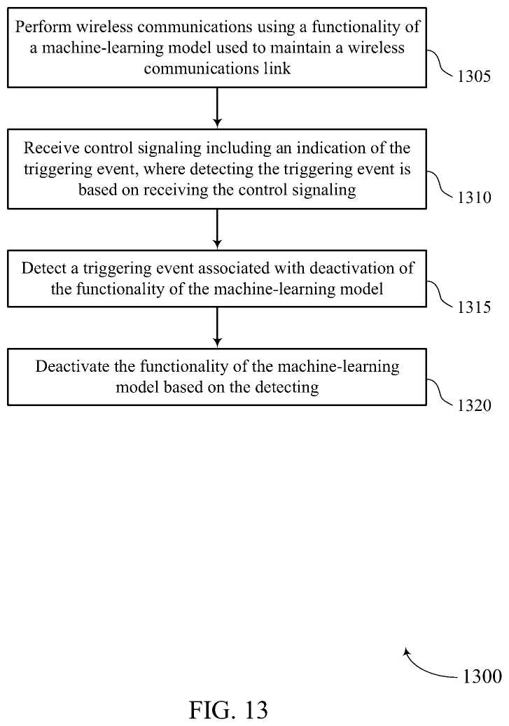

FIG. 13 shows a flowchart illustrating a method 1300 that supports event-triggered activation and deactivation of ML functionality in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the wireless UE to perform the described functions. Additionally, or alternatively, the wireless UE may perform aspects of the described functions using special-purpose hardware.

At 1305, the method may include performing wireless communications using a functionality of a ML model used to maintain a wireless communications link. The operations of 1305 may be performed in accordance with examples as disclosed herein. In some examples, aspects of the operations of 1305 may be performed by an ML functionality manager 625 as described with reference to FIG. 6.

At 1310, the method may include receiving control signaling including an indication of the triggering event, where detecting the triggering event is based on receiving the control signaling. The operations of 1310 may be performed in accordance with examples as disclosed herein. In some examples, aspects of the operations of 1310 may be performed by a triggering event configuration manager 640 as described with reference to FIG. 6.

At 1315, the method may include detecting a triggering event associated with deactivation of the functionality of the ML model. The operations of 1315 may be performed in accordance with examples as disclosed herein. In some examples, aspects of the operations of 1315 may be performed by a triggering event manager 630 as described with reference to FIG. 6.

At 1320, the method may include deactivating the functionality of the ML model based on the detecting. The operations of 1320 may be performed in accordance with examples as disclosed herein. In some examples, aspects of the operations of 1320 may be performed by an LCM operation manager 635 as described with reference to FIG. 6.

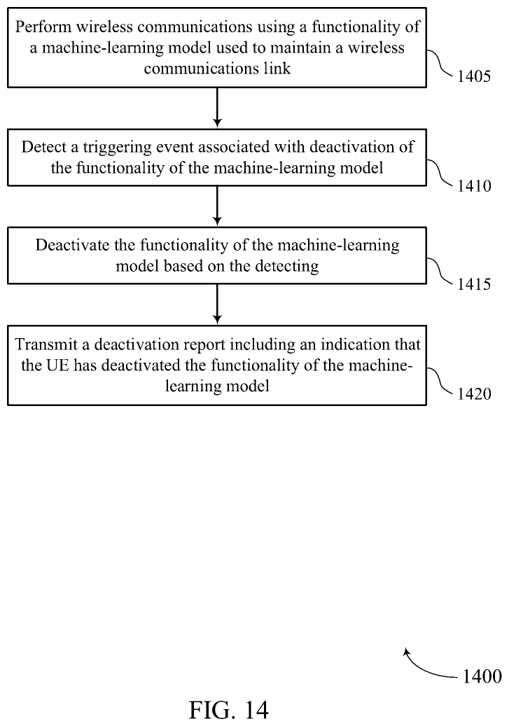

FIG. 14 shows a flowchart illustrating a method 1400 that supports event-triggered activation and deactivation of ML functionality in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the wireless UE to perform the described functions. Additionally, or alternatively, the wireless UE may perform aspects of the described functions using special-purpose hardware.

At 1405, the method may include performing wireless communications using a functionality of a ML model used to maintain a wireless communications link. The operations of 1405 may be performed in accordance with examples as disclosed herein. In some examples, aspects of the operations of 1405 may be performed by an ML functionality manager 625 as described with reference to FIG. 6.

At 1410, the method may include detecting a triggering event associated with deactivation of the functionality of the ML model. The operations of 1410 may be performed in accordance with examples as disclosed herein. In some examples, aspects of the operations of 1410 may be performed by a triggering event manager 630 as described with reference to FIG. 6.

At 1415, the method may include deactivating the functionality of the ML model based on the detecting. The operations of 1415 may be performed in accordance with examples as disclosed herein. In some examples, aspects of the operations of 1415 may be performed by an LCM operation manager 635 as described with reference to FIG. 6.

At 1420, the method may include transmitting a deactivation report including an indication that the UE has deactivated the functionality of the ML model. The operations of 1420 may be performed in accordance with examples as disclosed herein. In some examples, aspects of the operations of 1420 may be performed by a deactivation report manager 645 as described with reference to FIG. 6.

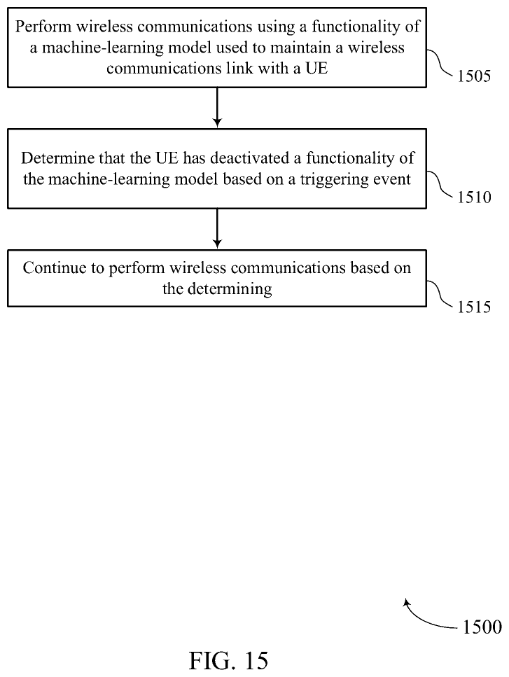

FIG. 15 shows a flowchart illustrating a method 1500 that supports event-triggered activation and deactivation of ML functionality in accordance with aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the wireless network entity to perform the described functions. Additionally, or alternatively, the wireless network entity may perform aspects of the described functions using special-purpose hardware.

At 1505, the method may include performing wireless communications using a functionality of a ML model used to maintain a wireless communications link with a UE. The operations of 1505 may be performed in accordance with examples as disclosed herein. In some examples, aspects of the operations of 1505 may be performed by an ML functionality manager 1025 as described with reference to FIG. 10.

At 1510, the method may include determining that the UE has deactivated a functionality of the ML model based on a triggering event. The operations of 1510 may be performed in accordance with examples as disclosed herein. In some examples, aspects of the operations of 1510 may be performed by an ML functionality operation manager 1030 as described with reference to FIG. 10.

At 1515, the method may include continuing to perform wireless communications based on the determining. The operations of 1515 may be performed in accordance with examples as disclosed herein. In some examples, aspects of the operations of 1515 may be performed by an ML functionality operation manager 1030 as described with reference to FIG. 10.

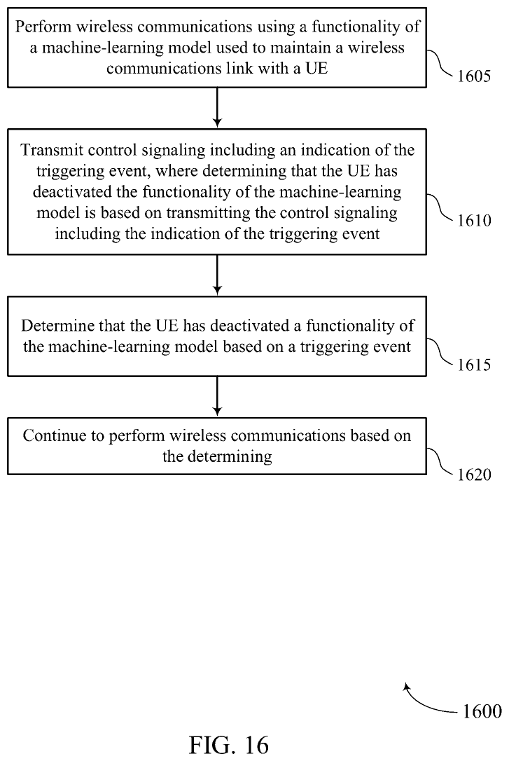

FIG. 16 shows a flowchart illustrating a method 1600 that supports event-triggered activation and deactivation of ML functionality in accordance with aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the wireless network entity to perform the described functions. Additionally, or alternatively, the wireless network entity may perform aspects of the described functions using special-purpose hardware.

At 1605, the method may include performing wireless communications using a functionality of a ML model used to maintain a wireless communications link with a UE. The operations of 1605 may be performed in accordance with examples as disclosed herein. In some examples, aspects of the operations of 1605 may be performed by an ML functionality manager 1025 as described with reference to FIG. 10.

At 1610, the method may include transmitting control signaling including an indication of the triggering event, where determining that the UE has deactivated the functionality of the ML model is based on transmitting the control signaling including the indication of the triggering event. The operations of 1610 may be performed in accordance with examples as disclosed herein. In some examples, aspects of the operations of 1610 may be performed by a triggering event manager 1035 as described with reference to FIG. 10.

At 1615, the method may include determining that the UE has deactivated a functionality of the ML model based on a triggering event. The operations of 1615 may be performed in accordance with examples as disclosed herein. In some examples, aspects of the operations of 1615 may be performed by an ML functionality operation manager 1030 as described with reference to FIG. 10.

At 1620, the method may include continuing to perform wireless communications based on the determining. The operations of 1620 may be performed in accordance with examples as disclosed herein. In some examples, aspects of the operations of 1620 may be performed by an ML functionality operation manager 1030 as described with reference to FIG. 10.

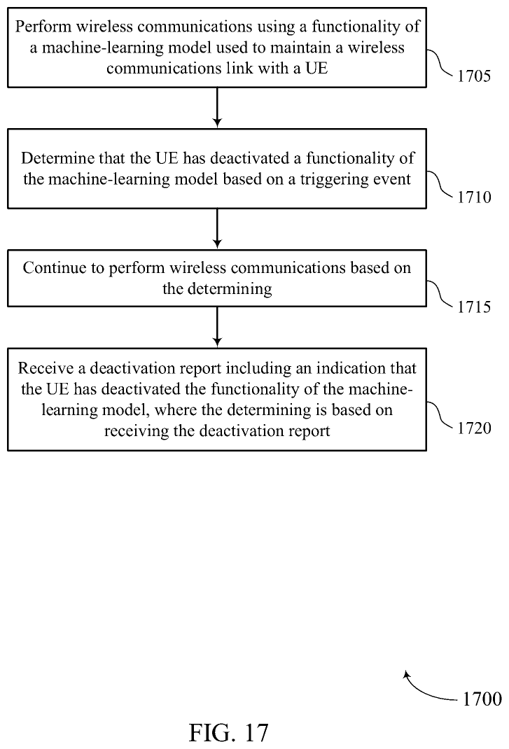

FIG. 17 shows a flowchart illustrating a method 1700 that supports event-triggered activation and deactivation of ML functionality in accordance with aspects of the present disclosure. The operations of the method 1700 may be implemented by a network entity or its components as described herein. For example, the operations of the method 1700 may be performed by a network entity as described with reference to FIGS. 1 through 3 and 8 through 11. In some examples, a network entity may execute a set of instructions to control the functional elements of the wireless network entity to perform the described functions. Additionally, or alternatively, the wireless network entity may perform aspects of the described functions using special-purpose hardware.

At 1705, the method may include performing wireless communications using a functionality of a ML model used to maintain a wireless communications link with a UE. The operations of 1705 may be performed in accordance with examples as disclosed herein. In some examples, aspects of the operations of 1705 may be performed by an ML functionality manager 1025 as described with reference to FIG. 10.

At 1710, the method may include determining that the UE has deactivated a functionality of the ML model based on a triggering event. The operations of 1710 may be performed in accordance with examples as disclosed herein. In some examples, aspects of the operations of 1710 may be performed by an ML functionality operation manager 1030 as described with reference to FIG. 10.

At 1715, the method may include continuing to perform wireless communications based on the determining. The operations of 1715 may be performed in accordance with examples as disclosed herein. In some examples, aspects of the operations of 1715 may be performed by an ML functionality operation manager 1030 as described with reference to FIG. 10.

At 1720, the method may include receiving a deactivation report including an indication that the UE has deactivated the functionality of the ML model, where the determining is based on receiving the deactivation report. The operations of 1720 may be performed in accordance with examples as disclosed herein. In some examples, aspects of the operations of 1720 may be performed by an LCM operation reporting manager 1040 as described with reference to FIG. 10.

The following provides an overview of aspects of the present disclosure:
Aspect 1: A method for wireless communications at a UE, comprising: performing wireless communications using a functionality of a ML model used to maintain a wireless communications link; detecting a triggering event associated with deactivation of the functionality of the ML model; and deactivating the functionality of the ML model based at least in part on the detecting.
Aspect 2: The method of aspect 1, further comprising: receiving control signaling comprising an indication of the triggering event, wherein detecting the triggering event is based at least in part on receiving the control signaling.
Aspect 3: The method of any of aspects 1 through 2, further comprising: transmitting a deactivation report comprising an indication that the UE has deactivated the functionality of the ML model.
Aspect 4: The method of aspect 3, further comprising: continuing to perform wireless communications via the wireless communications link based at least in part on deactivating the functionality of the ML model.
Aspect 5: The method of any of aspects 1 through 4, wherein detecting the triggering event comprises: monitoring reference signals for one or more beam failures; initiating a beam failure detection timer based at least in part on the monitoring and detecting a first beam failure instance comprising a block error rate corresponding to a first reference signal failing to satisfy a block error rate threshold; and detecting a beam failure based at least in part on a quantity of beam failure instances occurring before expiration of the beam failure detection timer satisfies a threshold quantity.
Aspect 6: The method of aspect 5, further comprising: receiving control signaling corresponding to a beam failure recovery procedure, the control signaling comprising an indication of the beam failure detection timer, the block error rate threshold, and the threshold quantity; and transmitting a beam failure report indicating the beam failure based at least in part on detecting the beam failure, wherein deactivating the functionality of the ML model is based at least in part on transmitting the beam failure report.
Aspect 7: The method of any of aspects 1 through 6, further comprising: receiving control signaling indicating event parameters to use to activate or deactivate the functionality of the ML model, the control signaling comprising an indication of a value of a beam failure detection timer, a value of a block error rate threshold, and a value of a threshold quantity that are associated with activating or deactivating the functionality of the ML model, wherein detecting the triggering event is based at least in part on the event parameters.
Aspect 8: The method of any of aspects 1 through 7, wherein detecting the triggering event comprises: detecting an entering into a geographic region associated with a zone identifier, wherein deactivating the functionality of the ML model is based at least in part on detecting the entering the geographic region.
Aspect 9: The method of aspect 8, further comprising: receiving control signaling indicating the zone identifier, wherein detecting the entering the geographic region is based at least in part on receiving the control signaling indicating the zone identifier.
Aspect 10: The method of aspect 9, further comprising: detecting beam failure in one or more geographic regions corresponding to one or more respective zone identifiers; and transmitting a report comprising an indication of the one or more respective zone identifiers, wherein receiving the control signaling indicating the zone identifier is based at least in part on transmitting the report.
Aspect 11: The method of any of aspects 1 through 10, wherein detecting the triggering event comprises: determining that one or more parameters fail to satisfy a threshold during a time duration, wherein deactivating the functionality of the ML model is based at least in part on the determining.
Aspect 12: The method of aspect 11, further comprising: receiving control signaling comprising an indication of the threshold and the time duration, wherein the determining is based at least in part on receiving the control signaling comprising the indication of the threshold and the time duration.
Aspect 13: The method of any of aspects 11 through 12, further comprising: transmitting a report indicating that the one or more parameters fail to satisfy the threshold during the time duration.
Aspect 14: The method of any of aspects 11 through 13, wherein the one or more parameters comprise a block error rate, a reference signal receive power, a throughput value, or any combination thereof.
Aspect 15: A method for wireless communications at a network entity, comprising: performing wireless communications using a functionality of a ML model used to maintain a wireless communications link with a UE; determining that the UE has deactivated a functionality of the ML model based at least in part on a triggering event; and continuing to perform wireless communications based at least in part on the determining.
Aspect 16: The method of aspect 15, further comprising: transmitting control signaling comprising an indication of the triggering event, wherein determining that the UE has deactivated the functionality of the ML model is based at least in part on transmitting the control signaling comprising the indication of the triggering event.
Aspect 17: The method of any of aspects 15 through 16, further comprising: receiving a deactivation report comprising an indication that the UE has deactivated the functionality of the ML model, wherein the determining is based at least in part on receiving the deactivation report.
Aspect 18: The method of any of aspects 15 through 17, wherein the triggering event comprises a beam failure.
Aspect 19: The method of aspect 18, further comprising: transmitting control signaling corresponding to a beam failure recovery procedure, the control signaling comprising an indication of a beam failure detection timer, a block error rate threshold, and a threshold quantity of beam failure instances, wherein the determining is based at least in part on transmitting the control signaling corresponding to the beam failure recovery procedure.
Aspect 20: The method of any of aspects 15 through 19, further comprising: transmitting control signaling indicating event parameters to use to activate or deactivate the functionality of the ML model, the control signaling comprising an indication of a value of a beam failure detection timer, a value of a block error rate threshold, and a value of a threshold quantity of beam failure instances that are associated with activating or deactivating the functionality of the ML model, wherein deactivating the functionality of the ML model is based at least in part on transmitting the control signaling.
Aspect 21: The method of aspect 20, further comprising: receiving, based at least in part on transmitting the control signaling corresponding to the functionality of the machine-learning model, an indication that the functionality of the ML model has been deactivated, wherein the determining is based at least in part on receiving the indication that the functionality of the ML model has been deactivated.
Aspect 22: The method of any of aspects 15 through 21, further comprising: transmitting control signaling indicating a zone identifier corresponding to deactivation of the functionality of the ML model; and receiving a report comprising an indication that the UE has entered a geographic area corresponding to the zone identifier, wherein the determining is based at least in part on receiving the indication that the UE has entered the geographic area.
Aspect 23: The method of aspect 22, further comprising: receiving, from a plurality of UEs, a plurality of reports comprising indications of one or more respective zone identifiers comprising the zone identifier, the one or more respective zone identifiers corresponding to geographic locations corresponding to deactivation of the functionality of the ML model, wherein transmitting the control signaling indicating the zone identifier is based at least in part on the plurality of reports.
Aspect 24: The method of any of aspects 15 through 23, further comprising: receiving control signaling comprising an indication of a threshold and a time duration, wherein the determining is based at least in part on receiving the control signaling comprising the indication of the threshold and the time duration.
Aspect 25: The method of any of aspects 15 through 24, wherein the triggering event comprises one or more parameters failing to satisfy a threshold during a time duration.
Aspect 26: The method of aspect 25, further comprising: transmitting control signaling comprising an indication of the threshold and the time duration, wherein the determining is based at least in part on transmitting the control signaling comprising the indication of the threshold and the time duration.
Aspect 27: The method of any of aspects 25 through 26, further comprising: receiving a report indicating that the one or more parameters fail to satisfy the threshold during the time duration, wherein the determining is based at least in part on receiving the report.
Aspect 28: The method of any of aspects 25 through 27, wherein the one or more parameters comprise a block error rate, a reference signal receive power, a throughput value, or any combination thereof.
Aspect 29: An apparatus for wireless communications at a UE, comprising a processor; memory coupled with the processor; and instructions stored in the memory and executable by the processor to cause the apparatus to perform a method of any of aspects 1 through 14.
Aspect 30: An apparatus for wireless communications at a UE, comprising at least one means for performing a method of any of aspects 1 through 14.
Aspect 31: A non-transitory computer-readable medium storing code for wireless communications at a UE, the code comprising instructions executable by a processor to perform a method of any of aspects 1 through 14.
Aspect 32: An apparatus for wireless communications at a network entity, comprising a processor; memory coupled with the processor; and instructions stored in the memory and executable by the processor to cause the apparatus to perform a method of any of aspects 15 through 28.
Aspect 33: An apparatus for wireless communications at a network entity, comprising at least one means for performing a method of any of aspects 15 through 28.
Aspect 34: A non-transitory computer-readable medium storing code for wireless communications at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor;
memory coupled with the processor; and
instructions stored in the memory and executable by the processor to cause the apparatus to:
perform wireless communications using a functionality of a machine-learning model used to maintain a wireless communications link;
detect a triggering event associated with deactivation of the functionality of the machine-learning model; and
deactivate the functionality of the machine-learning model based at least in part on the detecting.

2. The apparatus of claim 1, wherein the instructions are further executable by the processor to cause the apparatus to:
receive control signaling comprising an indication of the triggering event, wherein detecting the triggering event is based at least in part on receiving the control signaling.

3. The apparatus of claim 1, wherein the instructions are further executable by the processor to cause the apparatus to:
transmit a deactivation report comprising an indication that the UE has deactivated the functionality of the machine-learning model.

4. (canceled)

5. The apparatus of claim 1, wherein the instructions to detect the triggering event are executable by the processor to cause the apparatus to:
monitor reference signals for one or more beam failures;
initiate a beam failure detection timer based at least in part on the monitoring and detecting a first beam failure instance comprising a block error rate corresponding to a first reference signal failing to satisfy a block error rate threshold; and
detect a beam failure based at least in part on a quantity of beam failure instances occurring before expiration of the beam failure detection timer satisfies a threshold quantity.

6. The apparatus of claim 5, wherein the instructions are further executable by the processor to cause the apparatus to:
receive control signaling corresponding to a beam failure recovery procedure, the control signaling comprising an indication of the beam failure detection timer, the block error rate threshold, and the threshold quantity; and
transmit a beam failure report indicating the beam failure based at least in part on detecting the beam failure, wherein deactivating the functionality of the machine-learning model is based at least in part on transmitting the beam failure report.

7. The apparatus of claim 1, wherein the instructions are further executable by the processor to cause the apparatus to:
receive control signaling indicating event parameters to use to activate or deactivate the functionality of the machine-learning model, the control signaling comprising an indication of a value of a beam failure detection timer, a value of a block error rate threshold, and a value of a threshold quantity that are associated with activating or deactivating the functionality of the machine-learning model, wherein detecting the triggering event is based at least in part on the event parameters.

8. The apparatus of claim 1, wherein the instructions to detect the triggering event are executable by the processor to cause the apparatus to:
detect an entering into a geographic region associated with a zone identifier, wherein deactivating the functionality of the machine-learning model is based at least in part on detecting the entering the geographic region.

9. The apparatus of claim 8, wherein the instructions are further executable by the processor to cause the apparatus to:
receive control signaling indicating the zone identifier, wherein detecting the entering the geographic region is based at least in part on receiving the control signaling indicating the zone identifier.

10. The apparatus of claim 9, wherein the instructions are further executable by the processor to cause the apparatus to:
detect beam failure in one or more geographic regions corresponding to one or more respective zone identifiers; and
transmit a report comprising an indication of the one or more respective zone identifiers, wherein receiving the control signaling indicating the zone identifier is based at least in part on transmitting the report.

11. The apparatus of claim 1, wherein the instructions to detect the triggering event are executable by the processor to cause the apparatus to:
determine that one or more parameters fail to satisfy a threshold during a time duration, wherein deactivating the functionality of the machine-learning model is based at least in part on the determining.

12. The apparatus of claim 11, wherein the instructions are further executable by the processor to cause the apparatus to:
receive control signaling comprising an indication of the threshold and the time duration, wherein the determining is based at least in part on receiving the control signaling comprising the indication of the threshold and the time duration.

13. The apparatus of claim 11, wherein the instructions are further executable by the processor to cause the apparatus to:
transmit a report indicating that the one or more parameters fail to satisfy the threshold during the time duration.

14. The apparatus of claim 11, wherein the one or more parameters comprise a block error rate, a reference signal receive power, a throughput value, or any combination thereof.

15. An apparatus for wireless communications at a network entity, comprising:
a processor;
memory coupled with the processor; and
instructions stored in the memory and executable by the processor to cause the apparatus to:
perform wireless communications using a functionality of a machine-learning model used to maintain a wireless communications link with a user equipment (UE);
determine that the UE has deactivated the functionality of the machine-learning model based at least in part on a triggering event; and
continue to perform wireless communications based at least in part on the determining.

16. (canceled)

17. The apparatus of claim 15, wherein the instructions are further executable by the processor to cause the apparatus to:
receive a deactivation report comprising an indication that the UE has deactivated the functionality of the machine-learning model, wherein the determining is based at least in part on receiving the deactivation report.

18. The apparatus of claim 15, wherein the triggering event comprises a beam failure.

19. (canceled)

20. The apparatus of claim 15, wherein the instructions are further executable by the processor to cause the apparatus to:
transmit control signaling indicating event parameters to use to activate or deactivate the functionality of the machine-learning model, the control signaling comprising an indication of a value of a beam failure detection timer, a value of a block error rate threshold, and a value of a threshold quantity of beam failure instances that are associated with activating or deactivating the functionality of the machine-learning model, wherein deactivating the functionality of the machine-learning model is based at least in part on transmitting the control signaling.

21. (canceled)

22. The apparatus of claim 15, wherein the instructions are further executable by the processor to cause the apparatus to:
transmit control signaling indicating a zone identifier corresponding to deactivation of the functionality of the machine-learning model; and
receive a report comprising an indication that the UE has entered a geographic area corresponding to the zone identifier, wherein the determining is based at least in part on receiving the indication that the UE has entered the geographic area.

23-28. (canceled)

29. A method for wireless communications at a user equipment (UE), comprising:
performing wireless communications using a functionality of a machine-learning model used to maintain a wireless communications link;
detecting a triggering event associated with deactivation of the functionality of the machine-learning model; and
deactivating the functionality of the machine-learning model based at least in part on the detecting.

30. A method for wireless communications at a network entity, comprising:
performing wireless communications using a functionality of a machine-learning model used to maintain a wireless communications link with a user equipment (UE);
determining that the UE has deactivated the functionality of the machine-learning model based at least in part on a triggering event; and
continuing to perform wireless communications based at least in part on the determining.
